(19) United States
(12) Patent Application Publication
(10) Pub. No.: US 2015/0355788 A1
(43) Pub. Date: Dec. 10, 2015

(54) METHOD AND ELECTRONIC DEVICE FOR INFORMATION PROCESSING

(71) Applicant: LENOVO (BEIJING) CO., LTD., Beijing (CN)

(72) Inventor: Lu GAO, Beijing (CN)

(73) Assignee: LENOVO (BEIJING) CO., LTD., Beijing (CN)

(21) Appl. No.: 14/386,430

(22) PCT Filed: Feb. 25, 2014
(86) PCT No.: PCT/CN2014/072511

§ 371 Date: Sep. 19, 2014

(30) Foreign Application Priority Data
Mar. 1, 2013 (CN) 201310066065.1

(51) Int. Cl. G06F 3/0482; G06F 3/0488; G06F 3/0484; G06F 3/041

(52) U.S. Cl. CPC G06F 3/0482; G06F 3/0416; G06F 3/0488; G06F 3/04842

(57) ABSTRACT

Disclosed are a method and electronic device for information processing. The method comprises when the list interface is presented on the display unit, detecting whether or not a touch operation used for adjusting an M-number of items among the N-number of items from a current first position to a second position that is different from the first is found, where N is an integer greater than or equal to 2, and M is an integer greater than or equal to 1 and less than N; when the touch operation is detected, responding to the touch operation and generating a first instruction; executing the first instruction, and adjusting the M-number of items from the first position to the second position.

### CROSS REFERENCE TO RELATED APPLICATIONS

This application is a national phase application based on international application number PCT/CN2014/072511, filed on Feb. 25, 2014, which claims priority of Chinese Patent Application No. 201310066065.1, filed on Mar. 1, 2013, the contents of both of which are incorporated by reference herein in their entireties.

### TECHNICAL FIELD

The present application relates to the field of electronic technique, and more particularly to an information processing method and an electronic apparatus.

### BACKGROUND ART

At present, information for contacts in an address book or a text message inbox of a mobile phone all are sequenced according to a mode preset in advance at factory level. That is to say, usually contacts in an address book are sequenced in accordance with the order of the initial of the Chinese pronunciation of the name of the contact in the alphabet. If the initial of the first character of a name is a, then the initial of the second character is compared, and so on, and so forth; information for contacts in a text message inbox are usually sequenced in accordance with time or frequency of receiving text messages; for example, a text message contact A is originally sequenced at No. 3 in the text message inbox recording sequence, but if the user of the mobile phone contacts A through text messages, the position of A will be promoted to No. 1.

However, during the process of implementing the technical solutions in embodiments of the present application, the inventor of the present application discovers that the above technique has the following technical problem:

Contacts in an address book or a text message inbox are sequenced in accordance with certain rules in the prior art. The conventional mobile phone therefore has a technical problem in that the information arrangement mode is fixed, unitary, and cannot be adjusted arbitrarily. For example, if some users want information about specific persons, but these persons do not use text messages very often, then a situation may arise where the users cannot sequence contacts in a text message program in a self-defining manner so that text messages from these persons are not placed at the top of a text message list, thus reducing the experience of the users.

### SUMMARY

The embodiments of the present application provide an information processing method and an electronic apparatus, for solving the technical problem that exists in conventional mobile phones where the information arrangement mode is fixed, unitary, and cannot be adjusted arbitrarily.

In one aspect, an embodiment of the present application provides an information processing method applied to an electronic apparatus, which at least includes a display unit capable of rendering a list interface that includes N items, N being an integer more than or equal to two. The method includes detecting whether there is a touch control operation for adjusting M items among the N items from a current first position to a second position different from the first when the list interface is rendered on the display unit, M being an integer more than or equal to one but less than N; generating a first instruction in response to the touch control operation when detecting the touch control operation; and executing the first instruction to adjust the M items from the first position to the second position.

Optionally, prior to detecting whether there is a touch control operation for adjusting M items among the N items from a current first position to a second position different from the first, the method further includes detecting to obtain a screening operation for screening the M items from the N items in accordance with a preset screening rule; generating a screening instruction in response to the screening operation; and executing the screening instruction to screen the M items from the N items.

Optionally, detecting to obtain a screening operation for screening the M items from the N items in accordance with a preset screening rule specifically is detecting to obtain a screening operation for screening the M items from the N items in accordance with reception time of an item.

Optionally, detecting to obtain a screening operation for screening the M items from the N items in accordance with a preset screening rule specifically is detecting to obtain a screening operation for screening the M items from the N items based on name of a contact in an item.

Optionally, executing the first instruction to adjust the M items from the first position to the second position specifically includes obtaining an i-th item among the M items, i being an arbitrary integer between one and M; adjusting the i-th item from the first position to the second position; and when i=M, adjusting the M-th item from the first position to the second position, and thereby adjusting the M items from the first position to the second position.

Optionally, executing the first instruction to adjust the M items from the first position to the second position specifically is adjusting the M items from the first position to the second position all at once.

Optionally, the first application specifically is a text message program, an email program, or an address book program.

Optionally, after executing the first instruction to adjust the M items from the first position to the second position, the method further includes detecting to obtain a fixing operation for fixing one or more items among the M items at a third position; generating a fixing instruction in response to the fixing operation; and executing the fixing operation to fix the one or more items among the M items at the third position.

In another aspect, an embodiment of the present application further provides an electronic apparatus, which at least includes a display unit capable of rendering a list interface that includes N items, N being an integer more than or equal to two. The electronic apparatus further includes a first detecting unit for detecting whether there is a touch control operation for adjusting M items among the N items from a first current position to a second position different from the first when the list interface is rendered on the display unit, M being an integer more than or equal to one but less than N; a first generating unit for generating a first instruction in response to the touch control operation when detecting the touch control operation; and an adjusting unit for executing the first instruction to adjust the M items from the first position to the second position.

Optionally, the electronic apparatus further includes a second detecting unit for detecting to obtain a screening operation for screening the M items from the N items in accordance with a preset screening rule; a second generating unit for generating a screening instruction in response to the screening operation; and a screening unit for executing the screening instruction to screen the M items from the N items.

Optionally, the second detecting unit is specifically for detecting to obtain a screening operation for screening the M items from the N items in accordance with reception time of an item.

Optionally, the second detecting unit is specifically for detecting to obtain a screening operation for screening the M items from the N items based on name of a contact in an item.

Optionally, the adjusting unit specifically includes an obtaining subunit for obtaining an i-th item among the M items, i being an arbitrary integer between one and M; a first adjusting subunit for adjusting the i-th item from the first position to the second position; and a second adjusting subunit for when i=M, adjusting the M-th item from the first position to the second position, and thereby adjusting the M items from the first position to the second position.

Optionally, the adjusting unit is specifically for adjusting the M items from the first position to the second position all at once.

Optionally, the first application specifically is a text message program, an email program, or an address book program.

Optionally, the electronic apparatus further includes a third detecting unit for detecting to obtain a fixing operation for fixing one or more items among the M items at a third position; a third generating unit for generating a fixing instruction in response to the fixing operation; and a fixing unit for executing the fixing operation to fix the one or more items among the M items at the third position.

One or more technical solutions provided in the embodiments of the present application at least have the following technical effects or advantages:

(1) In the embodiments of the present application, since the technical measures of detecting a touch control operation for adjusting a position of an item, generating a first instruction for adjusting a position of an item in response to the touch control operation, and adjusting the position of information by executing the first instruction are adopted, the technical problem that exists in conventional mobile phones where the information arrangement mode is fixed, unitary, and cannot be adjusted arbitrarily is solved, and the technical effect of being capable of adjusting the position of information according to the touch control operation and thereby implementing change to the information arrangement mode is achieved.

(2) In the embodiments of the present application, since the technical measures whereby a user of a mobile phone screens contacts in a text message program according to a self-defining manner, and the mobile phone directly generates and executes an adjusting instruction in response to the user's screening operation, and thereby implements the adjustment of the position of screened contacts in the text message program are adopted, the technical problem that exists in conventional mobile phones where the information arrangement mode is fixed, unitary, and cannot be adjusted arbitrarily is further solved, and the technical effect that the mobile phone can arbitrarily adjust the sequence of contacts in the text message program based on a user self-defining manner is achieved.

### BRIEF DESCRIPTION OF THE DRAWINGS

FIG. 1 is a flowchart of process of an information processing method provided in an embodiment of the present application; and

FIG. 2 is a structural diagram of an electronic apparatus provided in an embodiment of the present application.

### DETAILED DESCRIPTION

The embodiments of the present application provide an information processing method and an electronic apparatus, for solving the technical problem that exists in conventional mobile phones where the information arrangement mode is fixed, unitary, and cannot be adjusted arbitrarily.

For solving the above problem, the technical solutions in the embodiments of the present application have a general concept as follows:

There is provided an information processing method applied to an electronic apparatus, which at least includes a display unit capable of rendering a list interface that includes N items, N being an integer more than or equal to two. The method includes detecting whether there is a touch control operation for adjusting M items among the N items from a current first position to a second position different from the first when the list interface is rendered on the display unit, M being an integer more than or equal to one but less than N; generating a first instruction in response to the touch control operation when detecting the touch control operation; and executing the first instruction to adjust the M items from the first position to the second position.

Thus it can be seen that in the embodiments of the present application, since the technical measures of detecting a touch control operation for adjusting the position of information, generating an instruction for adjusting the position of an item in response to the touch control operation, and adjusting the position of information by executing the adjusting instruction are adopted, the technical problem that exists in conventional mobile phones where the information arrangement mode is fixed, unitary, and cannot be adjusted arbitrarily is solved, and the technical effect that the position of information can be adjusted based on the adjusting operation, and thereby the information arrangement mode is adjusted is achieved.

To better understand the above technical solutions, detailed description will be provided with reference to the accompanying drawings attached to the specification and the specific implementing modes hereinafter. It will be appreciated that the embodiments of the present application and the specific features in the embodiments are detailed explanations of the technical solutions of the present application, rather than limitations to the technical solutions of the present application, and the embodiments of the present application and the technical features in the embodiments may be combined mutually in the case of no conflict.

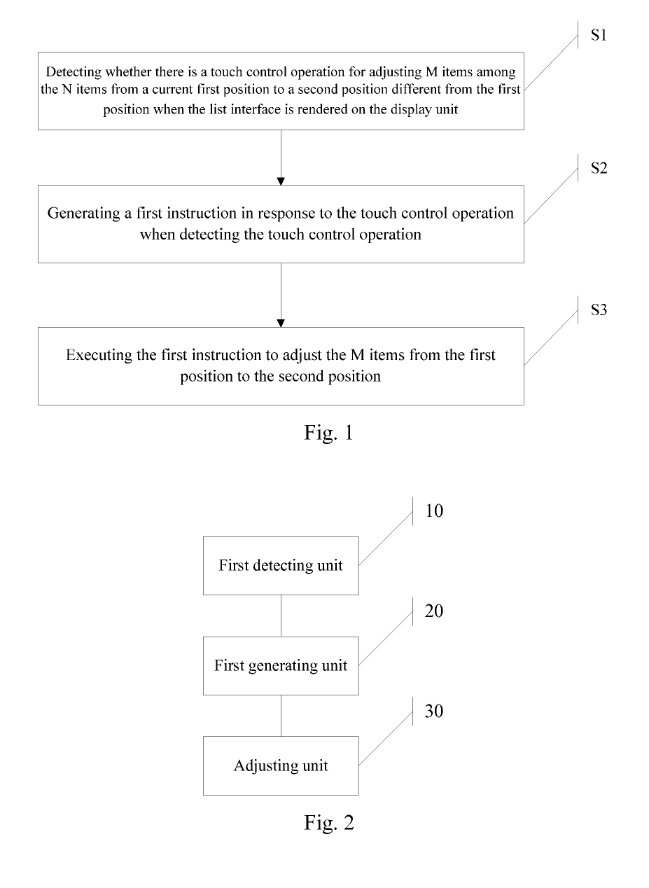

As shown in FIG. 1, the information processing method provided by the embodiment of the present application specifically includes a step of:

S1: detecting whether there is a touch control operation for adjusting M items among the N items from a current first position to a second position different from the first when the list interface is rendered on the display unit, N being an integer more than or equal to two, M being an integer more than or equal to one but less than N.

Furthermore, the first application specifically is a text message program, an email program, or an address book program.

In a specific implementation process, the electronic apparatus to which the information processing method provided by the embodiment of the present application is applied mainly refers to one having a text message program, an email program or an address book program and, when such programs are opened, the contents inside them are usually composed of N items of information. For example, an address book of a mobile phone usually stores therein N contacts, and a text message inbox of a mobile phone usually stores therein one or more items of text message contact information. These contacts are arranged in a certain order and stored in the address book or the text message inbox. In the embodiment of the present application, description is provided with the text message program in the mobile phone as an example. When the sequence of contacts corresponding to text messages stored in the text message inbox needs to be adjusted, through step S1, when the mobile phone opens the text message inbox to output contact text messages between N contacts and the user of the mobile phone, whether an adjusting operation for adjusting M items among the N items from a current first position to a second position different from the first is detected, wherein N is an integer more than or equal to two, M is an integer more than or equal to one but less than N (for example, when N is five, M is one, that is, five contacts that have text message contact with the user of the mobile phone are stored in the text message inbox of the mobile phone), and the position of the text message of one contact needs to be adjusted, assuming that the position of this contact in the text message program is No. 3, and it needs to be adjusted to No. 1, after the user of the mobile phone performs a selection operation and an adjusting operation on this contact on the mobile phone, subsequent operations will proceed based on the adjusting operation.

Furthermore, prior to detecting whether there is a touch control operation for adjusting M items among the N items from a current first position to a second position different from the first when the list interface is rendered on the display unit, the method further includes detecting to obtain a screening operation for screening the M items from the N items in accordance with a preset screening rule; generating a screening instruction in response to the screening operation; and executing the screening instruction to screen the M items from the N items.

In a specific implementation process, after the mobile phone opens the text message inbox to output contact text messages between N contacts and the user of the mobile phone, before step S1, the method provided by the embodiment of the present application further includes a screening step screening M contacts among the N contacts. When the user of the mobile phone wants to adjust the position of the text messages corresponding to M contacts as stored in the text message program, he/she performs a screening operation on the mobile phone, which detects it and, in response, a corresponding screening instruction is generated and executed, so as to select M contacts among the N contacts.

Furthermore, detecting to obtain a screening operation for screening the M items from the N items in accordance with a preset screening rule specifically is detecting to obtain a screening operation for screening the M items from the N items in accordance with reception time of an item.

Furthermore, detecting to obtain a screening operation for screening the M items from the N items in accordance with a preset screening rule specifically is detecting to obtain a screening operation for screening the M items from the N items based on name of a contact in an item.

In a specific implementation process, the screening operation detected by the mobile phone may be screening M contacts among N contacts based on the time limit of receiving and transmitting text messages with the contacts. For example, all the contacts that have a text message contact with the user of the mobile phone between May 10, 2012 and May 20, 2012 are screened from among the text messages transmitted from N contacts. M contacts may also be screened from N contacts in accordance with name sequence of the contacts. For example, all the contacts whose family names are “Wang” are screened from the text messages transmitted from N contacts. As for the screening rule based on which the screening operation is made, the embodiment of the present application makes no limitation thereto, such as in addition to screening in accordance with the receiving and transmitting time or the names of the contacts as described above, screening may also be made according to the contents of the text messages. The screening operation may be completed entirely according to self-definition of the user of the mobile phone, when the mobile phone detects that there is a screening operation of the user, it will generate a screening instruction based on such screening operation to screen M contacts.

Thus it can be seen that, in the embodiment of the present application, since the technical measures whereby a user of a mobile phone screens contacts in a text message program according to a self-defining manner, and the mobile phone directly generates and executes an adjusting instruction in response to the user's screening operation, and thereby implements the adjustment of the position of screened contacts in the text message program are adopted, the technical problem that exists in conventional mobile phones where the information arrangement mode is fixed, unitary, and cannot be adjusted arbitrarily is further solved, and the technical effect that mobile phone can arbitrarily adjust the sequence of contacts in the text message program based on a user self-defining manner is achieved.

S2: generating a first instruction in response to the touch control operation when detecting the touch control operation.

In a specific implementation process, the screening operation and the adjusting operation performed by the user on the contacts in the text message program of the mobile phone may be performed through a touch control display of the mobile phone, or through a non-touch control display input unit, such as a keyboard mouse etc., irrespective of the mode through which the screening operation and the adjusting operation are performed. If the mobile phone can detect and acquire such operations, when the mobile phone detects the adjusting operation performed by the user on M contacts among N contacts in the text message program, it generates a corresponding adjusting instruction to adjust M contacts from the first position to the second position.

S3: executing the first instruction to adjust the M items from the first position to the second position.

Furthermore, executing the first instruction to adjust the M items from the first position to the second position specifically includes obtaining an i-th item among the M items, i being an arbitrary integer between one and M; adjusting the i-th item from the first position to the second position; and when i=M, adjusting the M-th item from the first position to the second position, and thereby adjusting the M items from the first position to the second position.

Furthermore, executing the first instruction to adjust the M items from the first position to the second position specifically is adjusting the M items from the first position to the second position all at once.

In a specific implementation process, step S3 executes the adjusting instruction generated in step S2 to adjust the screened M contacts from the first position to the second position. The specific adjusting process may have two modes the first one concerns, adjustment made one by one with an i-th contact among the M contacts as a beginning. Let us say that M is five, and i may be any integer between one and five. Assuming that i is three, then the third contact is adjusted from the first position to the second position. After one adjustment, M is reduced to four, and i is any integer between one and four, so i takes on an arbitrary value between 1 and four. In this way, the adjustment is made in turn, since the sequence of the contacts in the text message program after each adjustment will always change, such adjustment has an advantage of being capable of flexibly arranging the text message contact that needs to be adjusted at an arbitrary position; the second concerns the fact that the five contacts are adjusted from the first position to the second position all at once, such adjustment mode is more convenient, the adjusted five contacts are adjusted from the first position to the second position as an entirety, and the adjacency position among the five contacts remains unchanged after the adjustment.

Furthermore, after step S3, the following step is further included detecting to obtain a fixing operation for fixing one or more items among the M items at a third position; generating a fixing instruction in response to the fixing operation; and executing the fixing operation to fix the one or more items among the M items at the third position.

In a specific implementation process, in order to further perfect the information processing method provided in the embodiment of the present application, after the positions of the M items among the N items are adjusted, a fixing operation may also be performed on one or more items among the M items. Since the information processing method provided in the embodiment of the present application is mainly applied to touch control smart mobile phones, the fixing operation therefore may be designed as a long press, a double click, or a touch control operation whose touch control pressure value arrives at a predetermined range, and so on. Hereinafter, illustration is made still with the text message program in the mobile phone as an example, and the fixing operation is, for example, a long press of more than two seconds.

Assuming that the user has adjusted the positions of five contacts in the text message program of the mobile phone, and the five contacts are A, B, C, D, and E, respectively, wherein the user adjusts the sequence position of A in the text message dialogue contacts to the top, adjusts B to No. 3, then after A and B are long-pressed for more than two seconds, respectively, the positions of A and B are always fixed at No. 1 and No. 3 in the text message dialogue contacts. Subsequently, when the user wants to sequence the text message dialogue contacts, the positions of C, D, and E may be dragged arbitrarily, but No. 1 and No. 3 will always remain as A and B in default, unless the user cancels the fixing of the two positions. The canceling operation may also be designed as a long press or a double click.

Thus, it can be seen that, in the embodiment of the present application, since a fixing step is further added after the technical measure of adjusting the positions of the M items among the N items, the technical effect of making the position of an adjusted item remain unchanged is achieved.

Based on the same inventive concept, an embodiment of the present application also provides an electronic apparatus, which at least includes a display unit capable of rendering a list interface that includes N items, N being an integer more than or equal to two. As shown in FIG. 2, the electronic device further comprises a first detecting unit 10 for detecting whether there is a touch control operation for adjusting M items among the N items from a current first position to a second position different from the first when the list interface is rendered on the display unit, M being an integer more than or equal to one but less than N; furthermore, the first application specifically is a text message program, an email program or an address book program; a first generating unit 20 for generating a first instruction in response to the touch control operation when detecting the touch control operation; and an adjusting unit 30 for executing the first instruction to adjust the M items from the first position to the second position.

Furthermore, the adjusting unit 30 specifically includes an obtaining subunit for obtaining an i-th item among the M items, i being an arbitrary integer between one and M; a first adjusting subunit for adjusting the i-th item from the first position to the second position; and a second adjusting subunit for when i=M, adjusting the M-th item from the first position to the second position, and thereby adjusting the M items from the first position to the second position.

The adjusting unit 30 is specifically for adjusting the M items from the first position to the second position all at once.

Furthermore, the electronic apparatus further includes a second detecting unit for detecting to obtain a screening operation for screening the M items from the N items in accordance with a preset screening rule; a second generating unit for generating a screening instruction in response to the screening operation; and a screening unit for executing the screening instruction to screen the M items from the N items.

Furthermore, the second detecting unit is specifically for detecting to obtain a screening operation for screening the M items from the N items in accordance with reception time of an item.

Furthermore, the second detecting unit is specifically for detecting to obtain a screening operation for screening the M items from the N items based on name of a contact in an item.

Furthermore, the electronic apparatus further includes a third detecting unit for detecting to obtain a fixing operation for fixing one or more items among the M items at a third position; a third generating unit for generating a fixing instruction in response to the fixing operation; and a fixing unit for executing the fixing operation to fix the one or more items among the M items at the third position.

To enable a person of ordinary skill in the art more clearly understand the method in the embodiment of the present application, an introduction is made with reference to a specific application scene:

Assuming that text message contacts with 20 contacts are stored in the text message program in the mobile phone of a smart mobile phone user, and the position of the text message of a contact A is arranged at No. 10, although the contact A and the user of the mobile phone do not always communicate with each other via text messages, the user of the mobile phone wants to concern the text message contact with the contact A once opening the text message program. However, the display screen of the mobile phone is limited and may not be able to display the No. 10 contact, so the user of the mobile phone must move the position of A in the text message sequence to a higher position, assuming that the position of A needs to be adjusted from No. 10 to No. 1. In this case, the user only needs to slide the screen of the mobile phone, select the contact A among the 20 text message contacts, then drag it to position No. 1. The mobile phone will detect the selecting (screening operation) and the dragging (adjusting operation) of the user, and generate an instruction to adjust the position of the contact A in response to said operations; of course, the user of the mobile phone may also adjust the positions of a plurality of contacts among the 20 contacts (for example, the contacts that are placed at the top five are adjusted to the positions as the last five).

One or more technical solutions provided in the embodiments of the present application at least have the following technical effects or advantages:

(1) In the embodiments of the present application, since the technical measures of detecting a touch control operation for adjusting a position of an item, generating a first instruction for adjusting a position of an item in response to the touch control operation, and adjusting the position of information by executing the first instruction are adopted, the technical problem that exists in conventional mobile phones where the information arrangement mode is fixed, unitary, and cannot be adjusted arbitrarily is solved, and the technical effect of being capable of adjusting the position of information according to the touch control operation and thereby implementing change to the information arrangement mode is achieved.

(2) In the embodiments of the present application, since the technical measures whereby a user of a mobile phone screens contacts in a text message program according to a self-defining manner, and the mobile phone directly generates and executes an adjusting instruction in response to the user's screening operation, and thereby implements the adjustment of the position of screened contacts in the text message program are adopted, the technical problem that exists in conventional mobile phones where the information arrangement mode is fixed, unitary, and cannot be adjusted arbitrarily is further solved, and the technical effect that the mobile phone can arbitrarily adjust the sequence of contacts in the text message program based on a user self-defining manner is achieved.

Obviously, it is possible for a person skilled in the art to make various modifications and variations to the present disclosure without departing from its spirit and scope. Thus, if these modifications and variations are within the scope of the claims and technical equivalents of the present disclosure, the present disclosure is also intended to include these modifications and variations.

What is claimed is:

1. An information processing method applied to an electronic apparatus, which at least includes a display unit capable of rendering a list interface that includes N items, N being an integer more than or equal to two, the method comprising:
detecting whether there is a touch control operation for adjusting M items among the N items from a current first position to a second position that is different from the first position when the list interface is rendered on the display unit, M being an integer more than or equal to one but less than N;
generating a first instruction in response to the touch control operation when detecting the touch control operation; and
executing the first instruction to adjust the M items from the first position to the second position.

2. The method of claim 1, wherein prior to detecting whether there is a touch control operation for adjusting M items among the N items from a current first position to a second position different from the first position, the method further comprising:
detecting to obtain a screening operation for screening the M items from the N items in accordance with a preset screening rule;
generating a screening instruction in response to the screening operation; and
executing the screening instruction to screen the M items from the N items.

3. The method of claim 2, wherein detecting to obtain a screening operation for screening the M items from the N items in accordance with a preset screening rule comprises
detecting to obtain a screening operation for screening the M items from the N items in accordance with reception time of an item.

4. The method of claim 2, wherein detecting to obtain a screening operation for screening the M items from the N items in accordance with a preset screening rule comprises detecting to obtain a screening operation for screening the M items from the N items based on name of a contact in an item.

5. The method of claim 1, wherein executing the first instruction to adjust the M items from the first position to the second position comprises:
obtaining an i-th item among the M items, i being an arbitrary integer between one and M;
adjusting the i-th item from the first position to the second position; and
when i=M, adjusting the M-th item from the first position to the second position, and thereby adjusting the M items from the first position to the second position.

6. The method of claim 1, wherein executing the first instruction to adjust the M items from the first position to the second position comprises adjusting the M items from the first position to the second position all at once.

7. The method of claim 1, wherein the first application specifically is a text message program or an email program or an address book program.

8. The method of claim 1, wherein after executing the first instruction to adjust the M items from the first position to the second position, the method further comprising:
detecting to obtain a fixing operation for fixing one or more items among the M items at a third position;
generating a fixing instruction in response to the fixing operation; and
executing the fixing operation to fix the one or more items among the M items at the third position.

9. An electronic apparatus, which at least includes a display unit capable of rendering a list interface that includes N items, N being an integer more than or equal to two, the electronic apparatus further comprising:
a first detecting unit for detecting whether there is a touch control operation for adjusting M items among the N items from a current first position to a second position different from the first position when the list interface is rendered on the display unit, M being an integer more than or equal to one but less than N;
a first generating unit for generating a first instruction in response to the touch control operation when detecting the touch control operation; and
an adjusting unit for executing the first instruction to adjust the M items from the first position to the second position.

10. The electronic apparatus of claim 9, wherein the electronic apparatus further comprising:
a second detecting unit for detecting to obtain a screening operation for screening the M items from the N items in accordance with a preset screening rule;
a second generating unit for generating a screening instruction in response to the screening operation; and
a screening unit for executing the screening instruction to screen the M items from the N items.

11. The electronic apparatus of claim 10, wherein the second detecting unit comprises detecting to obtain a screening operation for screening the M items from the N items in accordance with reception time of an item.

12. The electronic apparatus of claim 10, wherein the second detecting unit comprises detecting to obtain a screening operation for screening the M items from the N items based on name of a contact in an item.

13. The electronic apparatus of claim 9, wherein the adjusting unit specifically includes:
an obtaining subunit for obtaining an i-th item among the M items, i being an arbitrary integer between one and M;
a first adjusting subunit for adjusting the i-th item from the first position to the second position; and
a second adjusting subunit for when i=M, adjusting the M-th item from the first position to the second position, and thereby adjusting the M items from the first position to the second position.

14. The electronic apparatus of claim 9, wherein the adjusting unit comprises adjusting the M items from the first position to the second position all at once.

15. The electronic apparatus of claim 9, wherein the first application specifically is a text message program or an email program or an address book program.

16. The electronic apparatus of claim 9, further comprising:
a third detecting unit for detecting to obtain a fixing operation for fixing one or more items among the M items at a third position;
a third generating unit for generating a fixing instruction in response to the fixing operation; and
a fixing unit for executing the fixing operation to fix the one or more items among the M items at the third position.
